(19) United States
(12) Patent Application Publication
(10) Pub. No.: US 2025/0289735 A1
(43) Pub. Date: Sep. 18, 2025

(54) CATHODE ACTIVE MATERIAL FOR LITHIUM SECONDARY BATTERY AND LITHIUM SECONDARY BATTERY INCLUDING THE SAME

(71) Applicant: SK ON CO., LTD., Seoul (KR)

(72) Inventors: Hee Jun KWEON, Daejeon (KR); Jeong Bae YOON, Daejeon (KR); Sang Bok KIM, Daejeon (KR); Ji Hoon CHOI, Daejeon (KR)

(21) Appl. No.: 19/079,469

(22) Filed: Mar. 14, 2025

(30) Foreign Application Priority Data
Mar. 15, 2024 (KR) 10-2024-0036591

(51) Int. Cl. C01G 53/506; H01M 10/052

(52) U.S. Cl. CPC C01G 53/506; H01M 10/052; C01P 2002/52; C01P 2002/72; C01P 2006/40

(57) ABSTRACT

A cathode active material for a lithium secondary battery according to embodiments of the present invention includes lithium-nickel metal oxide particles having an expansion phase ratio of 30 to 40% and a contraction phase ratio of 35 to 45% measured in a voltage region of 3.75 V to 4.15 V by in-situ X-ray diffraction (in-situ XRD), and a content of Ni among metal elements except for lithium of 90 mol % to 99 mol %. A lithium secondary battery including the cathode active material may have improved lifespan characteristics.

### CROSS-REFERENCE TO RELATED APPLICATION AND CLAIM OF PRIORITY

This application claims priority to Korean Patent Applications No. 10-2024-0036591 filed on Mar. 15, 2024 in the Korean Intellectual Property Office (KIPO), the entire disclosure of which is incorporated by reference herein.

### BACKGROUND

### 1. Field of the Invention

The present invention relates to a cathode active material for a lithium secondary battery and a lithium secondary battery including the same.

### 2. Description of the Related Art

A secondary battery is a battery which can be repeatedly charged and discharged. With rapid progress of information and communication, and display industries, the secondary battery has been widely applied to various portable electronic telecommunication devices such as a camcorder, a mobile phone, a laptop computer as a power source thereof. Recently, a battery pack including the secondary battery has also been developed and applied to an eco-friendly automobile such as a hybrid vehicle as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, and is advantageous in terms of a charging speed and light weight, such that development thereof has been proceeded in this regard.

For example, the lithium secondary battery may include: an electrode assembly including a cathode, an anode, and a separation membrane (separator); and an electrolyte in which the electrode assembly is impregnated. The lithium secondary battery may further include, for example, a pouch-shaped outer case in which the electrode assembly and the electrolyte are housed.

As an active material for the cathode of the lithium secondary battery, lithium-nickel metal oxide may be used. Examples of the lithium-nickel metal oxide may include a nickel-based lithium metal oxide.

A lithium secondary battery having longer lifespan, high capacity, and operational stability is required as the application range thereof is expanded. In the lithium-nickel metal oxide used as the active material for the cathode, when non-uniformity in the chemical structure is increased due to distortion of a crystal structure, it may be difficult to implement a lithium secondary battery having desired capacity and lifespan. In addition, when deformation or damage of the lithium-nickel metal oxide structure is caused during repeated charging and discharging, lifespan stability and capacity retention characteristics may be decreased.

For example, Korean Patent Laid-Open Publication No. 10-2017-0093085 discloses a cathode active material including a transition metal compound and an ion adsorption binder, but there is a limitation in securing sufficient lifespan characteristics and stability.

### SUMMARY

An object of the present invention is to provide a cathode active material for a lithium secondary battery having improved lifespan characteristics and a lithium secondary battery including the cathode active material.

To achieve the above object, according to an aspect of the present invention, there is provided a cathode active material for a lithium secondary battery including: lithium-nickel metal oxide particles which include 90 mol % to 99 mol % of Ni among metal elements except for lithium, wherein a (113) plane peak of the lithium-nickel metal oxide particles measured through in-situ X-ray diffraction analysis (in-situ XRD) is separated into a main phase peak having the highest peak intensity in a voltage region of 3.75 V to 4.15 V; an expansion phase peak appearing at a first diffraction angle smaller than a main diffraction angle at which the main phase peak appears; and a contraction phase peak appearing at a second diffraction angle larger than the main diffraction angle, and a ratio of an integral area of the expansion phase peak to a sum of integral areas of the main phase peak, the expansion phase peak and the contraction phase peak is 30 to 40%, and a ratio of the integral area of the contraction phase peak to the sum of integral areas is 35 to 45%.

According to exemplary embodiments, a difference between the main diffraction angle and the first diffraction angle may be greater than 0 and 1° or less, and a difference between the main diffraction angle and the second diffraction angle may be greater than 0 and 1° or less.

According to exemplary embodiments, the lithium-nickel metal oxide particles may include at least one doping element.

According to exemplary embodiments, the lithium-nickel metal oxide particles may be represented by Formula 1 below:

LiₓNiₐCo_{b}Mn_{c}M_{d}O_{2+y} [Formula 1]

In Formula 1, M includes at least one of Ti, Zr, Al, Mg, Sr and W, and x, a, b, c, d and y satisfy 0.8<x<1.5, 0.90≤a≤0.99, 0≤b≤0.10, 0≤c≤0.10, 0≤d≤0.05, 0.98≤a+b+c≤1.02, −0.1≤y≤0.1.

According to exemplary embodiments, in Formula 1 above, a may be in a range of 0.94≤a≤0.98.

According to exemplary embodiments, in Formula 1 above, b may be in a range of 0≤b≤0.05.

According to exemplary embodiments, in Formula 1 above, c may be in a range of 0≤c≤0.05.

According to exemplary embodiments, in Formula 1 above, c may be b or less (c≤b).

According to exemplary embodiments, in Formula 1 above, M includes two or more of Ti, Zr, Al, Mg, Sr and W.

According to exemplary embodiments, a variation in a d value of the lithium-nickel metal oxide particles measured in a voltage region of greater than 4.15 V and 4.18 V or less through the in-situ X-ray diffraction analysis (in-situ XRD) may be 0.1 to 0.15.

According to exemplary embodiments, a variation in an a-axis lattice constant among the lattice constants of the lithium-nickel metal oxide particles measured through the in-situ X-ray diffraction analysis (in-situ XRD) may be 0.05 to 0.08 Å, and a variation in a c-axis lattice constant may be 0.8 to 1.2 Å.

According to another aspect of the present invention, there is provided a lithium secondary battery including: a cathode which includes the cathode active material for a lithium secondary battery; and an anode disposed to face the cathode.

The cathode active material for a lithium secondary battery according to exemplary embodiments of the present disclosure may implement a high-capacity lithium secondary battery by including Ni in a high content so that the content of Ni among metal elements except for lithium satisfies 90 mol % or more.

In the case of the cathode active material for a lithium secondary battery, a ratio of an expansion phase and a contraction phase measured in a low-voltage range, for example, a voltage region of 3.75 V to 4.15 V, through in-situ XRD satisfies a predetermined range, such that a cathode crystal structure may be maintained without collapsing even when repeatedly charging and discharging the lithium secondary battery.

Accordingly, even if the charging and discharging of the lithium secondary battery is repeated, a capacity of the battery may be maintained without causing a decrease, and gas generation due to a side reaction with an electrolyte caused by the collapse of the crystal structure of the cathode may be prevented.

In addition, in some embodiments, the cathode active material for a lithium secondary battery may further alleviate a rapid change in the crystal structure by including a doping metal. Accordingly, even if the content of Ni is increased, a decrease in the lifespan characteristics of the lithium secondary battery and an expansion of the battery may be prevented.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are a schematic plan view and a cross-sectional view illustrating a lithium secondary battery according to exemplary embodiments, respectively;

FIGS. 3 to 5 are in-situ XRD graphs illustrating a (003) plane peak change of lithium secondary batteries according to the examples, respectively; and

FIGS. 6 to 11 are contour plots of in-situ XRD illustrating a (113) plane peak change of the lithium secondary batteries according to the examples, respectively.

### DETAILED DESCRIPTION OF THE INVENTION

The embodiments of the present disclosure provide a cathode active material including lithium-nickel metal oxide particles and a lithium secondary battery including the cathode active material.

Hereinafter, the embodiments of the present disclosure will be described in detail. However, these embodiments are merely an example, and the present disclosure is not limited to the specific embodiments described as the example.

In exemplary embodiments, the cathode active material may include lithium-nickel metal oxide particles. For example, the lithium-nickel metal oxide particles may have a single crystal or polycrystalline structure in crystallography.

The cathode active material may include the lithium-nickel metal oxide particles. For example, an amount of the lithium-nickel metal oxide particles may be 50% by weight (“wt %”) or more based on a total weight of the cathode active material. Preferably, the amount of the lithium-nickel metal oxide particles may be 60 wt % or more, 70 wt % or more, 80 wt % or more, or 90 wt % or more based on the total weight of the cathode active material.

In one embodiment, the cathode active material may be substantially composed of particles of the lithium-nickel composite oxide.

According to some embodiments, the lithium-nickel metal oxide particles include nickel (Ni), and may further include at least one of cobalt (Co) and manganese (Mn). In addition, the particles may further include other doping metal elements.

Ni may be provided as a transition metal associated with output and capacity of the lithium secondary battery. Therefore, by employing the composition of high-nickel (high-Ni) contents in the lithium-nickel metal oxide particles, it is possible to provide a high-power cathode and a high-power lithium secondary battery.

In this regard, as the content of Ni is increased, long-term storage stability and lifespan stability of the cathode or secondary battery may be relatively reduced. However, according to exemplary embodiments, by including Co, the lifespan stability and capacity retention characteristics may be improved through Mn while maintaining electrical conductivity.

According to some embodiments, the content of Ni among the metal elements except for lithium in the lithium-nickel metal oxide particles may be 90 mol % to 99 mol %.

For example, the content of Ni among Ni, Co and Mn except for lithium in the lithium-nickel metal oxide particles may be 90 mol % to 99 mol %. In some embodiments, the content of Ni among the metal elements except for lithium in the lithium-nickel metal oxide particles may be 92 mol % to 99 mol %, 94 mol % to 99 mol %, or 94 mol % to 98 mol %.

When the content of Ni included in the lithium-nickel metal oxide particles is within the above range, structural stability and lifespan characteristics of the lithium secondary battery may be secured while implementing a high-capacity lithium secondary battery.

If the content of Ni included in the lithium-nickel metal oxide particles is less than 90 mol %, the capacity of the battery may not be sufficiently secured. In addition, if the content of Ni included in the lithium-nickel metal oxide particles is greater than 99 mol %, the crystal structure of the particles may be excessively unstable, such that the battery may be broken or expanded within a short period of time during repeated charging and discharging, thereby decreasing the lifespan characteristics.

According to an exemplary embodiment, the lithium-nickel metal oxide particles may include at least one doping element. The doping element may be included to prevent cracks that may occur in the lithium-nickel metal oxide particles. For example, the lithium-nickel metal oxide particles may include one, two or three doping elements.

The type of the doping element is not particularly limited, but may be at least one selected from the group consisting of Ti, Zr, Al, Mg, Sr and W in terms of stabilizing the cathode active material.

For example, the lithium-nickel metal oxide particle may have a secondary particle structure including a plurality of primary particles.

For example, a distortion between the lattice structures in the primary particles included in the lithium-nickel metal oxide particle or between the primary particles may occur according to charging and discharging of the lithium secondary battery. In this case, the distortion in the above-described lattice structure and/or crystal structure may cause a shift in the position and/or a change in the width of a peak when measured through X-ray diffraction analysis (XRD).

For example, changes in the lattice structure and/or crystal structure according to the charging/discharging state of the lithium secondary battery may be confirmed through the in-situ XRD analysis.

According to exemplary embodiments, changes in each crystal plane of lithium-nickel metal oxide particles may be confirmed on the basis of changes in the shape and position of the peak through in-situ X-ray diffraction analysis (in-situ XRD).

For example, the in-situ XRD analysis may be performed by preparing a cell using the lithium-nickel metal oxide as the cathode active material, irradiating the cell with X-rays while charging/discharging at about 0.1 C, and continuously obtaining in-situ XRD spectra.

Accordingly, data on the position and intensity of the peak in each XRD spectrum may be obtained. A contour plot may be represented through the obtained data on changes in the position and intensity of the continuous peaks. Through the contour plot, it is possible to confirm the intensity of the peak, changes in the position and whether the peak is separated, etc.

In some embodiments, it can be confirmed through the in-situ XRD that the peak corresponding to each crystal plane is separated into two or more peaks in a low-voltage range before the phase transition region of the lithium-nickel metal oxide particle.

In exemplary embodiments, it can be confirmed through the in-situ XRD that changes in the peak corresponding to the (003) plane, (101) plane, (105) plane, (107) plane, (113) plane, etc. of the lithium-nickel metal oxide particle

In exemplary embodiments, the lithium-nickel metal oxide particles measured through the in-situ X-ray diffraction (in-situ XRD) may have a (113) plane peak separated into three peaks in the low voltage range. For example, the low voltage range may be a voltage region of 3.75 V to 4.15 V.

In exemplary embodiments, in the voltage region of 3.75 V to 4.15 V, the (113) plane peak may be separated into a main phase peak, an expansion phase peak and a contraction phase peak. The main phase peak may be a peak having the highest peak intensity among the (113) plane peaks when separated into three. The expansion phase peak may be a peak appearing at a first diffraction angle smaller than a main diffraction angle at which the main phase peak appears. The contraction phase peak may be a peak appearing at a second diffraction angle larger than the main diffraction angle.

The main diffraction angle, the first diffraction angle and the second diffraction angle are 20 values corresponding to a horizontal axis of the spectrum as a result of in-situ XRD analysis, and may be expressed in units of ° (degrees).

In the charging process of the battery including a lithium-nickel metal oxide, the crystal structure of the lithium-nickel metal oxide particles varies, and the separation of peaks according thereto may be observed through the in-situ XRD.

According to exemplary embodiments, a ratio of an integral area of the expansion phase peak to a sum of integral areas of the main phase peak, the expansion phase peak and the contraction phase peak may be 30% to 40%. In some embodiments, the ratio of the integral area of the expansion phase peak to the sum of the integral areas of the main phase peak, the expansion phase peak and the contraction phase peak may be 32% to 40%, 32% to 38%, 34% to 38%, or 34% to 36%.

According to exemplary embodiments, a ratio of the integral area of the contraction phase peak to the sum of the integral areas of the main phase peak, the expansion phase peak and the contraction phase peak may be 35% to 45%. In some embodiments, the ratio of the integral area of the contraction phase peak to the sum of the integral areas of the main phase peak, the expansion phase peak and the contraction phase peak may be 37% to 45%, 38% to 44%, 39% to 44%, or 39% to 43%.

When satisfying the ratio within the above range, the lithium-nickel metal oxide particles may maintain a stable crystal structure even during charging and discharging, thereby improving the lifespan characteristics of the lithium secondary battery. In addition, a side reaction with the electrolyte of the lithium secondary battery may be prevented to inhibit gas generation, and thus volume expansion of the battery may be suppressed.

If the ratio of the integral area of the expansion phase peak to the sum of the integral areas of the peaks deviates from the above range, or the ratio of the integral area of the contraction phase peak deviates from the above range, the crystal structure of the lithium-nickel metal oxide is excessively distorted or irreversibly changed, and when the charging and discharging are repeated, the capacity of the lithium secondary battery may be significantly decreased.

According to exemplary embodiments, a difference between the main diffraction angle and the first diffraction angle at which the expansion phase peak appears may be greater than 0 and 1° or less, and the difference between the main diffraction angle and the second diffraction angle at which the contraction phase peak appears may be greater than 0 and 1° or less. For example, when the main phase peak is observed at a 2θ value of about 68.5°, the expansion phase peak may be observed within a 2θ value range of about 67.5° or more and less than 68.5°, and the contraction phase peak may be observed within a 20 value range of greater than about 68.5° and about 69.5° or less.

The expansion phase peak may have a larger d-value (d-spacing) than that of the main phase peak, and the contraction phase peak may have a smaller d-value than that of the main phase peak. The d-value may refer to a lattice spacing measured by the XRD analysis. That is, the crystal lattice is relatively expanded, such that the expansion phase may have a larger d-value than the d-value of the main phase, and the crystal lattice is relatively contracted, such that the contraction phase may have a smaller d-value than the d-value of the main phase.

If the contraction phase ratio of the lithium-nickel metal oxide particles measured in the voltage region of 3.75 V to 4.15 V through the in-situ X-ray diffraction (in-situ XRD) is greater than 45%, the lithium-nickel metal oxide particles may be excessively unstable during charging and discharging, thereby the lifespan characteristics of the lithium secondary battery may be decreased.

As described above, the lattice structure and/or crystal structure of the lithium-nickel metal oxide particles may vary during battery charging and discharging. For example, the (003) plane among the crystal planes of the lithium-nickel metal oxide particle may undergo a phase transition between an H2 phase and an H3 phase during charging and discharging. In this phase transition process, a form in which an H2 peak moves to an H3 peak may be confirmed through the in-situ XRD.

In this case, an intermediate peak may exist in the phase transition process between the H2 peak and the H3 peak of the (003) plane. The intermediate peak may appear between positions of the H2 peak and the H3 peak. For example, the intermediate peak may appear between the H2 peak which appears at about 18.5° and the H3 peak which appears at about 19.5°, that is, at positions of 18.5° or more and 19.5° or less.

The intermediate peak may have a weaker peak intensity than the H2 peak and the H3 peak. Accordingly, in the in-situ XRD analysis results, it can be confirmed that the peak intensity is slightly decreased and the peak shifts in the phase transition process.

According to an exemplary embodiment, the lithium-nickel metal oxide particle may have a (003) plane peak intermediate intensity ratio of 50% or more, which is measured through the in-situ X-ray diffraction analysis and defined by Equation 1 below. Alternatively, the (003) plane peak intermediate intensity ratio of the lithium-nickel metal oxide particle defined by Equation 1 below may be 60% or more.

$$( 003 ) plane peak intermediate intensity ratio ( \% ) = 100 \times ( {I}_{003 , H 2 - H 3} / {I}_{003 , H 2} ) \qquad [ Equation 1 ]$$

In Equation 1, I_{003,H2} is a maximum peak intensity of the H2 phase of the (003) plane of the lithium-nickel metal oxide particles measured through the in-situ XRD, and I_{003,H2-H3} is a minimum peak intensity value in the H2-H3 phase transition process of the (003) plane of the lithium-nickel metal oxide particles measured through the in-situ XRD.

The lithium-nickel metal oxide particles may have a high intermediate peak intensity in the H2-H3 phase transition process of the (003) plane, such that the peak change pattern may be smooth. Accordingly, the crystal structure of the cathode active material may be more stable during charging and discharging, and a cathode active material and a lithium secondary battery having improved lifespan characteristics may be implemented. According to an exemplary embodiment, the lithium-nickel metal oxide particles may be represented by Formula 1 below.

LiₓNiₐCo_{b}Mn_{c}M_{d}O_{2+y} [Formula 1]

In Formula 1, M includes at least one of Ti, Zr, Al, Mg, Sr and W, and x, a, b, c, d and y may satisfy 0.8<x<1.5, 0.90≤a≤0.99, 0≤b≤0.10, 0≤c≤0.10, 0≤d≤0.05, 0.98≤a+b+c≤1.02, −0.1≤y≤0.1.

According to an exemplary embodiment, in Formula 1, a may be in a range of 0.94≤a≤0.98.

According to an exemplary embodiment, in Formula 1, b may be in a range of 0≤b≤0.05.

According to an exemplary embodiment, in Formula 1, c may be in a range of 0≤c≤0.05.

According to an exemplary embodiment, in Formula 1, c may be b or less (c≤b). In some embodiments, the content of Co may be greater than the content of Mn. For example, the content of Mn (c) may be 0 and the content of Co (b) may be greater than 0 and 0.05 or less, or greater than 0 and 0.02 or less.

According to an exemplary embodiment, in Formula 1 above, M may mean a doping metal. The doping metal (M) may include two or more of Ti, Zr, Al, Mg, Sr and W. Preferably, the doping metal (M) includes three or more of Ti, Zr, Al, Mg, Sr and W.

According to an exemplary embodiment, a variation in the d value of the lithium-nickel metal oxide particles measured in a voltage region of greater than 4.15 V and 4.18 V or less through the in-situ X-ray diffraction analysis may be 0.1 to 0.15.

For example, the lithium-nickel metal oxide particles may undergo a phase transition within a high voltage band, for example, within a voltage range of 4.16 V to 4.18 V. When the phase transition occurs, the crystal structure within the particles may vary, and thereby the d value (d-spacing) measured by the in-situ X-ray diffraction analysis may vary.

The variation in the d value may be a difference value between the minimum value and the maximum value of the d value measured by the in-situ X-ray diffraction analysis in charging and discharging processes of the lithium secondary battery.

If the d value is within the above range, a variation in the layered structure of the lithium-nickel metal oxide particles during charging and discharging is not excessive, such that the stability of the cathode active material may be improved.

According to an exemplary embodiment, a lattice constant of the lithium-nickel metal oxide particles measured through the in-situ X-ray diffraction analysis (in-situ XRD) may be determined. For example, the lattice constant of the lithium-nickel metal oxide particles may be determined through crystal structure analysis by the Rietveld method in a space group R-3m crystal structure through the in-situ XRD analysis.

According to an exemplary embodiment, the variation in an a-axis lattice constant among the lattice constants of the lithium-nickel metal oxide particles measured through the in-situ X-ray diffraction analysis (in-situ XRD) may be 0.05 to 0.08 Å. In some embodiments, the variation in the a-axis lattice constant may be 0.05 to 0.07 Å.

According to an exemplary embodiment, the variation in a c-axis lattice constant among the lattice constants of the lithium-nickel metal oxide particles measured through the in-situ X-ray diffraction analysis (in-situ XRD) may be 0.8 to 1.2 Å. In some embodiments, the variation in the c-axis lattice constant may be 0.8 to 1.1 Å.

The variation in the a-axis lattice constant and the variation in the c-axis lattice constant may be a difference value between the minimum value and the maximum value of the a-axis lattice constant and the c-axis lattice constant, respectively, measured by the in-situ X-ray diffraction analysis in the charging and discharging processes of the lithium secondary battery.

When having the variation in the a-axis lattice constant and the variation in the c-axis lattice constant are within the above range, distortion in the crystal structure of the lithium-nickel metal oxide due to the battery charging and discharging may occur less frequently. Accordingly, long-term stability of the lithium secondary battery may be improved.

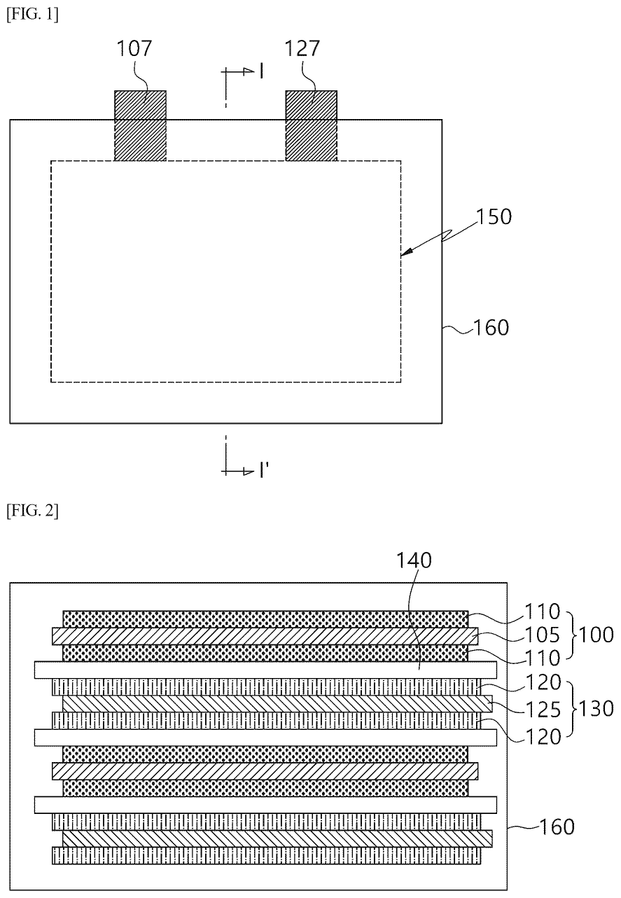

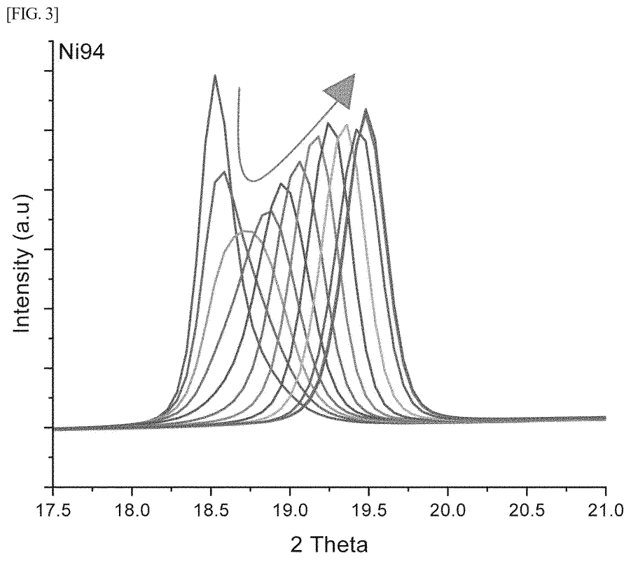

Hereinafter, a lithium secondary battery including a cathode which includes the cathode active material for a lithium secondary battery will be described with reference to FIGS. 1 and 2.

Referring to FIGS. 1 and 2, the lithium secondary battery may include a cathode 100 including the above-described cathode active material which includes a coating containing a lithium-sulfur compound and a metal hydroxide, and an anode 130 disposed to face the cathode 100.

The cathode 100 may include a cathode active material layer 110 formed by applying the above-described cathode active material including the lithium-transition metal oxide particles to a cathode current collector 105.

For example, a slurry may be prepared by mixing the cathode active material prepared by the above-described preparation method with a binder, a conductive agent and/or a dispersant in a solvent, followed by stirring the same. The slurry may be applied to at least one surface of the cathode current collector 105, followed by drying and compressing to prepare the cathode 100.

The cathode current collector 105 may include, for example, stainless steel, nickel, aluminum, titanium, copper, or an alloy thereof, and preferably includes aluminum or an aluminum alloy.

The binder may be selected from, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as a binder for forming a cathode. In this case, an amount of the binder for forming the cathode active material layer 110 may be reduced and an amount of the cathode active material may be relatively increased, thereby improving the output and capacity of the secondary battery.

The conductive material may be included to facilitate electron transfer between the active material particles. For example, the conductive material may include a carbon-based conductive material such as graphite, carbon black, graphene, or carbon nanotubes and/or a metal-based conductive material such as tin, tin oxide, titanium oxide, or a perovskite material such as LaSrCoO₃, and LaSrMnO₃.

The anode 130 may include an anode current collector 125 and an anode active material layer 120 formed by coating the anode current collector 125 with an anode active material.

The anode active material useable in the present invention may include any material known in the related art, so long as it can intercalate and deintercalate lithium ions, without particular limitation thereof. For example, carbon-based materials such as crystalline carbon, amorphous carbon, carbon composite, carbon fiber, etc.; a lithium alloy; silicon or tin may be used. Examples of the amorphous carbon may include hard carbon, cokes, mesocarbon microbead (MCMB) calcined at 1500° C. or lower, mesophase pitch-based carbon fiber (MPCF) or the like. Examples of the crystalline carbon may include graphite-based carbon such as natural graphite, graphite cokes, graphite MCMB, graphite MPCF or the like. Other elements included in the lithium alloy may include, for example, aluminum, zinc, bismuth, cadmium, antimony, silicone, lead, tin, gallium, indium or the like.

The anode current collector 125 may include, for example, gold, stainless steel, nickel, aluminum, titanium, copper, or an alloy thereof, and preferably includes copper or a copper alloy.

In some embodiments, a slurry may be prepared by mixing the anode active material with a binder, a conductive material and/or a dispersant in a solvent, followed by stirring the same. The slurry may be coated on the anode current collector 120, followed by drying and compressing to manufacture the anode 130.

As the binder and the conductive material, materials which are substantially the same as or similar to the above-described materials may be used. In some embodiments, a binder for forming an anode may include, for example, an aqueous binder such as styrene-butadiene rubber (SBR) for consistency with the carbon-based active material, and may be used together with a thickener such as carboxymethyl cellulose (CMC).

The separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane 140 may include a nonwoven fabric made of glass fiber having a high melting point, polyethylene terephthalate fiber or the like.

According to exemplary embodiments, an electrode cell is defined by the cathode 100, the anode 130, and the separation membrane 140, and a plurality of electrode cells are stacked to form, for example, a jelly roll type electrode assembly 150. For example, the electrode assembly 150 may be formed by winding, lamination, folding, and the like of the separation membrane 140.

The electrode assembly may be housed in an outer case 160 together with an electrolyte to define the lithium secondary battery. According to exemplary embodiments, a non-aqueous electrolyte may be used as the electrolyte.

The non-aqueous electrolyte includes a lithium salt of an electrolyte and an organic solvent. The lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻; CF₃CF₂SO₃⁻; (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethylsulfuroxide, acetonitrile, dimethoxyethane, diethoxyethane, vinylene carbonate, sulfolane, gamma-butyrolactone, propylene sulfite and tetrahydrofuran, etc. may be used. These may be used alone or in combination of two or more thereof.

As illustrated in FIG. 1, electrode tabs (a cathode tab and an anode tab) protrude from the cathode current collector 105 and the anode current collector 125, respectively, which belong to each electrode cell, and may extend to one side of the outer case 160. The electrode tabs may be fused together with the one side of the outer case 160 to form electrode leads (a cathode lead 107 and an anode lead 127) extending or exposed to an outside of the outer case 160.

The lithium secondary battery may be manufactured, for example, in a cylindrical shape using a can, a square shape, a pouch type or a coin shape.

Hereinafter, experimental examples including specific examples and comparative examples are proposed to facilitate understanding of the present invention. However, the following examples are only given for illustrating the present invention and those skilled in the art will obviously understand that various alterations and modifications are possible within the scope and spirit of the present invention. Such alterations and modifications are duly included in the appended claims.

### Example 1

### (1) Preparation of Lithium-Nickel Metal Oxide Particles

A solution was prepared by mixing NiSO₄, CoSO₄ and MnSO₄ in a ratio of 0.94:0.05:0.01 in distilled water from which internal dissolved oxygen was removed by bubbling with N₂ for 24 hours. The solution was input into a reactor at 50° C., and a coprecipitation reaction was performed for 48 hours using NaOH and NH₃H₂O as a precipitant and a chelating agent, respectively, to obtain Ni_{0.94}Co_{0.05}Mn_{0.01}(OH)₂ as a transition metal precursor. The obtained precursor was dried at 80° C. for 12 hours, and then again dried at 110° C. for 12 hours.

Lithium hydroxide and the transition metal precursor were added to a dry high-speed mixer in a ratio of 1.03:1, and then uniformly mixed for 5 minutes to prepare a mixture.

The mixture was put into a calcination furnace, and heated to about 750° C. at a rate of 2° C./min, then maintained at about 750° C. for 10 hours. Oxygen was continuously passed at a flow rate of 20 L/min during heating and maintenance. After completion of the calcination, the mixture was naturally cooled to room temperature, followed by pulverization and classification to prepare lithium-nickel metal oxide particles having a composition of Li_{1.03}Ni_{0.94}Co_{0.05}Mn_{0.01}O₂.

### (2) Manufacturing of Lithium Secondary Battery

A lithium secondary battery was manufactured using the obtained lithium-nickel metal oxide particles as a cathode active material.

Specifically, the cathode active materials, Denka Black as a conductive material and PVDF as a binder were mixed in a mass ratio composition of 97:2:1, respectively, to prepare a cathode slurry. The prepared cathode slurry was applied to an aluminum current collector, followed by drying and pressing the same to prepare a cathode.

An anode slurry, which includes 93 wt % of natural graphite as an anode active material, 5 wt % of KS6 as a flake type conductive material, 1 wt % of styrene-butadiene rubber (SBR) as a binder, and 1 wt % of carboxymethyl cellulose (CMC) as a thickener, was prepared. The anode slurry was applied to a copper substrate, followed by drying and pressing the same to prepare an anode.

The cathode and the anode prepared as described above were respectively notched in a predetermined size and stacked, then an electrode cell was fabricated by interposing a separator (polyethylene, thickness: 25 μm) between the cathode and the anode. Thereafter, tap parts of the cathode and the anode were welded, respectively. The upper surface, lower surface, and middle surface (spacer) of an outside of the coin cell were punched with a diameter of 3 mm, and imide tapes were attached to the punched portions to block contact with oxygen from the outside.

A combination of the welded cathode/separator/anode was put into the coin cell, an electrolyte was injected, then clamped and sealed, followed by impregnation for 12 hours or more

The electrolyte used herein was prepared by dissolving LiPF₆ in a mixed solvent of EC/EMC/DEC (25/45/30; volume ratio) to have a concentration of 1M, then adding 1 wt % of vinylene carbonate (VC), 0.5 wt % of 1,3-propene sultone (PRS), and 0.5 wt % of lithium bis(oxalato)borate (LiBOB) thereto.

Then, pre-charging was conducted on the secondary battery manufactured as described above with a current (5 A) corresponding to 0.25 C for 36 minutes. After 1 hour, degassing then aging for 24 hours or more were conducted, followed by performing formation charging-discharging (charging condition: CC-CV 0.2 C 4.2 V 0.05 C CUT-OFF; discharging condition: CC 0.2 C 2.5 V CUT-OFF).

### Example 2

A lithium secondary battery was manufactured according to the same procedures as described in Example 1, except that lithium-nickel metal oxide particles having a composition of Li_{1.03}Ni_{0.96}Co_{0.03}Mn_{0.01}O₂ were obtained by mixing NiSO₄, CoSO₄ and MnSO₄ in a ratio of 0.96:0.03:0.01.

### Example 3

A lithium secondary battery was manufactured according to the same procedures as described in Example 1, except that lithium-nickel metal oxide particles having a composition of Li_{1.03}Ni_{0.98}Co_{0.02}O₂ were obtained by mixing NiSO₄ and CoSO₄ in a ratio of 0.98:0.02.

### Example 4

A lithium secondary battery was manufactured according to the same procedures as described in Example 1 except that NiSO₄ and CoSO₄ were mixed in a ratio of 0.98:0.02 to obtain Ni_{0.98}Co_{0.02}(OH)₂ as a transition metal precursor, lithium hydroxide and the transition metal precursor were added to a dry high-speed mixer in a ratio of 1.03:1, zirconium oxide (ZrO₂ ) was added so that Zr was 4000 ppm based on a total number of moles of Ni and Co, and then uniformly mixed for 5 minutes and calcined to obtain lithium-nickel metal oxide particles having a composition of Li_{1.03}(Ni_{0.98}Co_{0.02})_{0.996}Zr_{0.004}O₂.

### Example 5

A lithium secondary battery was manufactured according to the same procedures as described in Example 1, except that NiSO₄ and CoSO₄ were mixed in a ratio of 0.98:0.02 to obtain Ni_{0.98}Co_{0.02}(OH)₂ as a transition metal precursor, lithium hydroxide and the transition metal precursor were added to a dry high-speed mixer in a ratio of 1.03:1, zirconium oxide (ZrO₂) and strontium hydroxide (Sr(OH)₃) were added so that Zr and Sr were each 2000 ppm based on the total number of moles of Ni and Co, and then uniformly mixed for 5 minutes and calcined to obtain lithium-nickel metal oxide particles having a composition of Li_{1.03}(Ni_{0.98}Co_{0.02})_{0.996}Zr_{0.002}Sr_{0.002}O₂.

### Example 6

A lithium secondary battery was manufactured according to the same procedures as described in Example 1, except that NiSO₄ and CoSO₄ were mixed in a ratio of 0.98:0.02 to obtain Ni_{0.98}Co_{0.02}(OH)₂ as a transition metal precursor, lithium hydroxide and the transition metal precursor were added to a dry high-speed mixer in a ratio of 1.03:1, aluminum hydroxide (Al(OH)₃), titanium hydroxide (Ti(OH)₂) and strontium hydroxide (Sr(OH)₃) were added so that Al, Ti and Sr were 1000 ppm, 2000 ppm and 700 ppm, respectively based on the total number of moles of Ni and Co, and then uniformly mixed for 5 minutes and calcined to obtain lithium-nickel metal oxide of particles having a composition Li_{1.03}(Ni_{0.98}Co_{0.02})_{0.9963}Al_{0.001}Ti_{0.002}Sr_{0.0007}O₂.

### Comparative Example 1

A lithium secondary battery was manufactured according to the same procedures as described in Example 1, except that NiSO₄, CoSO₄ and MnSO₄ were mixed in a ratio of 0.88:0.09:0.03 to obtain lithium-nickel metal oxide particles having a composition of Li_{1.03}Ni_{0.88}Co_{0.09}Mn_{0.03}O₂.

### Comparative Example 2

Ni(NO₃)₂, Co(NO₃)₂ and Mn(NO₃)₂ were mixed in a ratio of 0.94:0.05:0.01 in distilled water from which internal dissolved oxygen was removed by bubbling with N₂ for 24 hours to prepare a solution. Citric acid was input into the solution, stirred at 120° C., and then ammonia water was added to adjust the pH of the solution to about 8.5. Thereafter, the solution was dried in an oven at 110° C. for 12 hours to obtain Ni_{0.94}Co_{0.05}Mn_{0.01}(OH)₂ as a transition metal precursor. Lithium hydroxide and the transition metal precursor were added to a dry high-speed mixer in a ratio of 1.03:1, and then uniformly mixed for 5 minutes to prepare a mixture.

The mixture was put into a calcination furnace, and heated to 750° C. at a rate of 2° C./min, then maintained at about 750° C. Oxygen was continuously passed at a flow rate of 20 L/min during heating and maintenance. A lithium secondary battery was manufactured according to the same procedures as described in Example 1, except that, after completion of the calcination, the mixture was naturally cooled to room temperature, followed by pulverization and classification to prepare lithium-nickel metal oxide particles having a composition of Li_{1.03}Ni_{0.94}Co_{0.05}Mn_{0.01}O₂.

### Experimental Example

(1) In-Situ XRD Analysis of lithium-Transition Metal Oxide Particles
1) Analysis of crystalline phase

After conducting a formation process by performing charging (CC-CV 0.1 C 4.3 V 0.05C CUT-OFF) and discharging (CC 0.1 C 3.0 V CUT-OFF) on the coin cells of the examples and comparative examples once, in-situ measurement was performed using X'Pert PRO, Empyren (Panalytical Co.) equipment as the in-situ XRD under the following conditions.
Anode material: Cu
K-Alpha1 wavelength: 1.540598 Å
Generator voltage: 45 kV
Tube current: 40 mA
Scan range: 10-120°
Scan step size: 0.0065°
Divergence slit: ¼°
Antiscatter slit: 1°

The coin cell was put into in-situ XRD, and charging (CC-CV 0.1 C 4.3 V 0.05 C CUT-OFF) and discharging (CC 0.1 C 3 V CUT-OFF) were performed once each, and XRD was measured once every minute in each charging and discharging process to measure the integrated area ratio and d-value (d-spacing) of each peak of the expansion phase, main phase and contraction phase of the (113) plane within the voltage region of 3.75 V to 4.18 V.

### 2) Analysis of Lattice Constant Change

The lithium secondary batteries of the examples and comparative examples were each put into the in-situ XRD described above in 1), and the XRD was measured once after charging and discharging to determine the lattice constant, then a variation in the lattice constant was calculated as a difference between the maximum value and the minimum value.

The measurement values are shown in Table 1.

### 3) Confirmation of Peak Phase Transition Pattern of (003) Plane

The lithium secondary batteries of the examples and comparative examples were each put into the in-situ XRD described above in 1), and the XRD was measured once to confirm the peak change of the (003) plane.

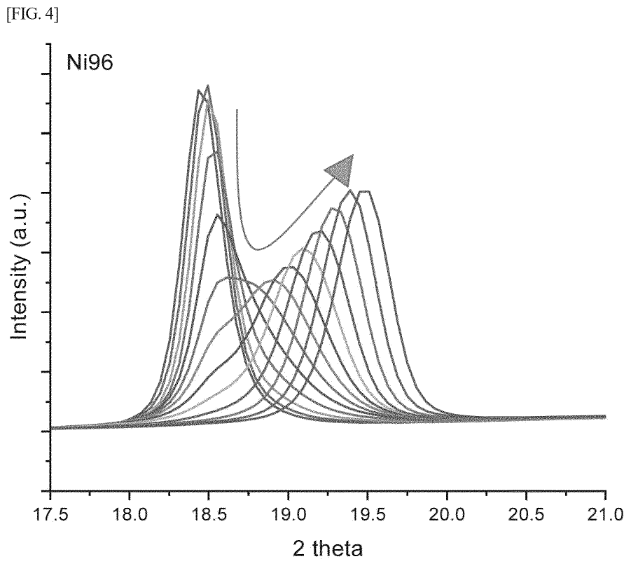

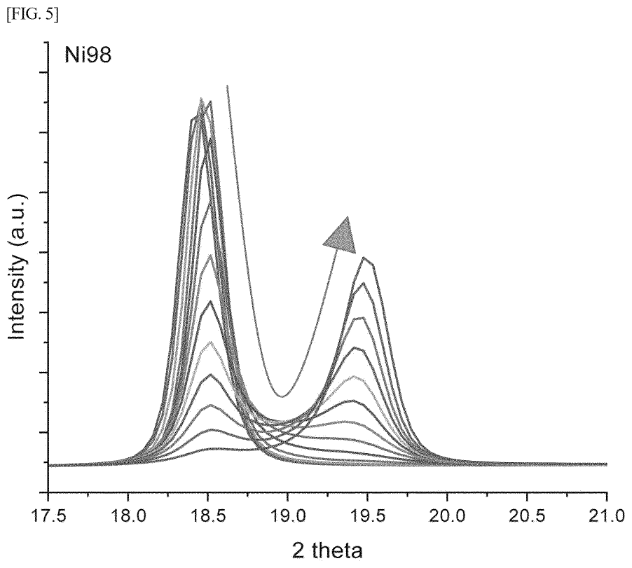

FIGS. 3 to 5 are in-situ XRD graphs illustrating the (003) plane peak change of the lithium secondary batteries of Examples 1 to 3, respectively.

From FIGS. 3 to 5, the peak intermediate intensity ratio according to Equation 1 was calculated, and results thereof are shown in Table 2.

$$( 003 ) plane peak intermediate intensity ratio ( \% ) = 100 \times ( {I}_{003 , H 2 - H 3} / {I}_{003 , H 2} ) \qquad [ Equation 1 ]$$

In Equation 1, I_{003,H2} is a maximum peak intensity of the H2 phase of the (003) plane of the lithium-nickel metal oxide particles measured through the in-situ XRD, and I_{003,H2-H3} is a minimum peak intensity value in the H2-H3 phase transition process of the (003) plane of the lithium-nickel metal oxide particles measured through the in-situ XRD.

Although in-situ XRD graphs illustrating the (003) plane peak change of the lithium secondary batteries according to Examples 4 to 6 and the comparative examples were not inserted into this specification, the peak intermediate intensity ratios were calculated using the same method as above, and results thereof are shown in Table 2.

### 4) Confirmation of Peak Separation Pattern Upon Phase Transition of (113) Plane

The lithium secondary batteries of the examples and comparative examples were each put into the in-situ XRD described above in 1), and the XRD was measured once to confirm the peak change of the (113) plane, respectively.

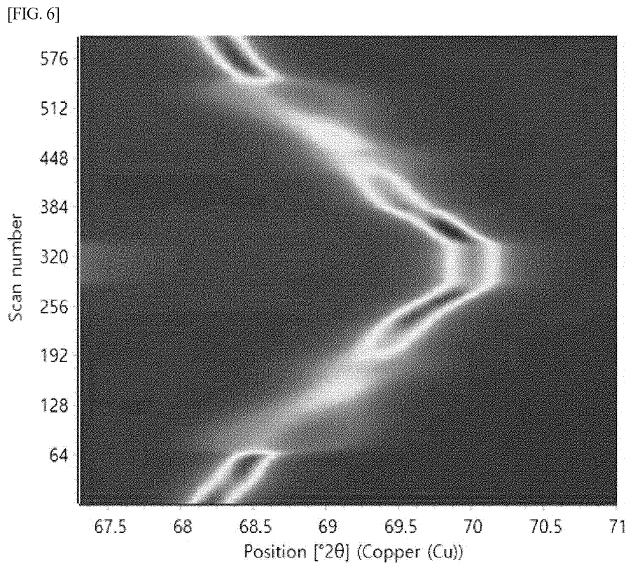

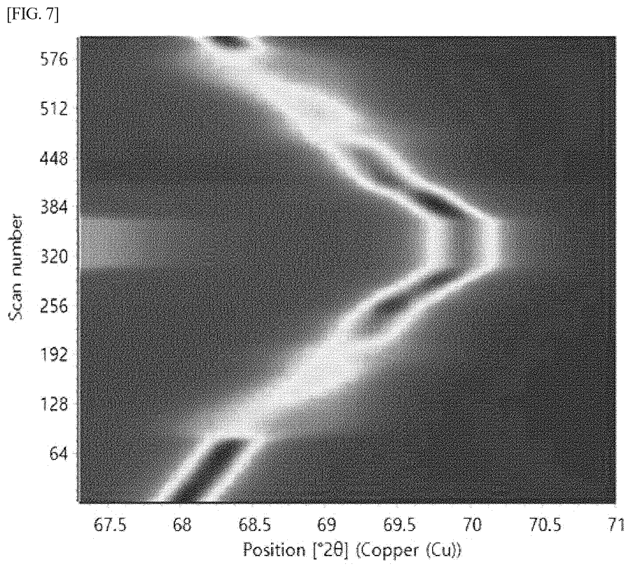

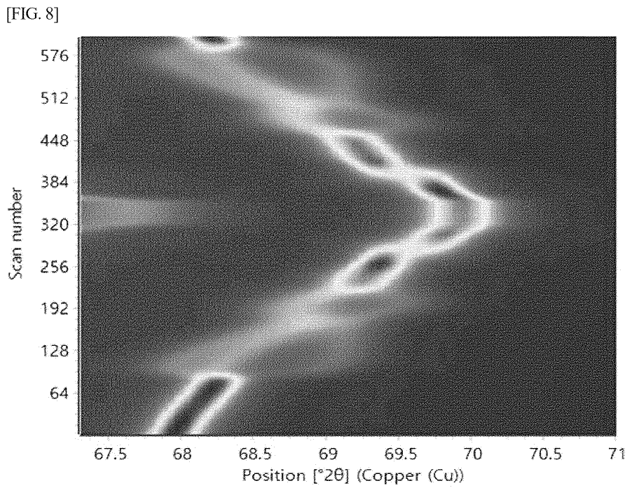

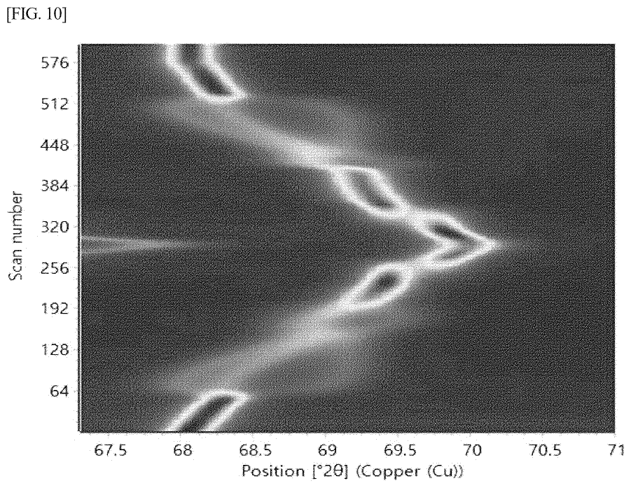

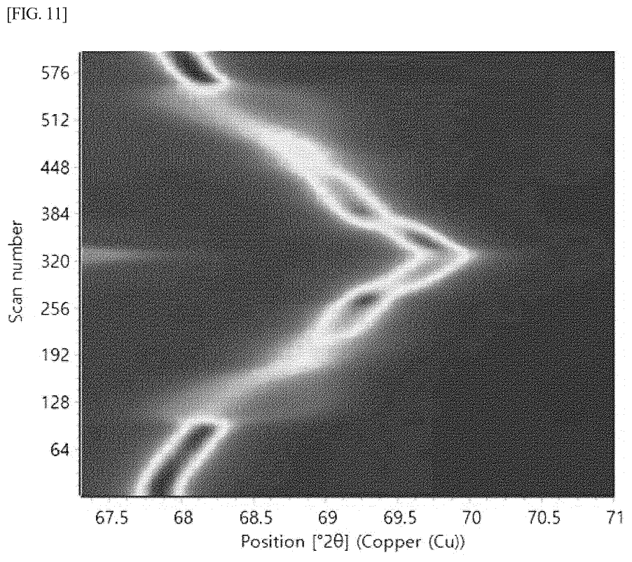

FIGS. 6 to 11 are contour plots of in-situ XRD illustrating the (113) plane peak change of the lithium secondary batteries according to Examples 1 to 6, respectively.

### (2) Evaluation of Efficiency of Lithium Secondary Batteries

The lithium secondary batteries of the examples and comparative examples were charged, and charge capacity and discharge capacity were measured, respectively, then the battery efficiency was calculated by dividing the discharge capacity by the charge capacity. The discharge capacities, charge capacities, and efficiencies are shown in Table 3.

### (3) Measurement of Variation in Volume of Lithium Secondary Batteries

The lithium secondary batteries of the examples and comparative examples were left in a chamber at 60°° C. for 4 weeks. Thereafter, the batteries were left at room temperature for 30 minutes and put into a chamber to measure the gas generation amount. After forming a vacuum in the chamber, nitrogen gas was filled to form atmospheric pressure therein. At this time, a nitrogen volume (V₀) and an internal pressure (P₀) of the chamber were measured. After forming a vacuum again inside the chamber, a hole was drilled in the battery and an internal pressure (P₁) of the chamber was measured, and the gas generation amount was calculated according to Equation 2 below. The gas generation amounts are shown in Table 3.

$$Gas generation amount ( mL ) = ( {V}_{0} / {P}_{0} ) \times {P}_{1} \qquad [ Equation 2 ]$$

### (4) Measurement of Capacity Retention Rate During Repeated Charging and Discharging of Lithium Secondary Batteries

Charging (CC/CV 0.5 C 4.3 V 0.05C CUT-OFF) and discharging (CC 1.0 C 3.0 V CUT-OFF) were repeated on the lithium secondary batteries according to the examples and comparative examples 500 times in a chamber at 25° C. Then, the capacity retention rate was evaluated as a percentage of the discharge capacity at 500 times divided by the discharge capacity at one time. The capacity retention rates are shown in Table 3.

TABLE 1

| | | | | Low-voltage range (3.75 V-4.15 V | | | | | |
|---|---|---|---|---|---|---|---|---|---|
| | | | | voltage region), (113) plane | | | | | |
| | Phase transition range | | | Expansion | | | | Contraction | |
| | (4.15 V-4.18 V voltage region) | | | phase | | Main phase | | phase | |
| | Maximum | Minimum | | d | Phase | d | Phase | d | Phase |
| | d Value | d Value | Δd | Value | ratio | Value | ratio | Value | ratio |
| | (Å) | (Å) | (Å) | (Å) | (%) | (Å) | (%) | (Å) | (%) |
| Example 1 | 2.4235 | 2.309 | 0.1145 | 0.8293 | 34.1 | 0.8278 | 26.9 | 0.8253 | 39 |
| Example 2 | 2.4351 | 2.3067 | 0.1284 | 0.8301 | 35.2 | 0.8281 | 24.2 | 0.8249 | 41.6 |
| Example 3 | 2.4359 | 2.3065 | 0.1294 | 0.8331 | 35.1 | 0.8288 | 21.6 | 0.8246 | 43.3 |
| Example 4 | 2.4359 | 2.3067 | 0.1292 | 0.8355 | 36.5 | 0.8292 | 19.8 | 0.8240 | 43.7 |
| Example 5 | 2.4358 | 2.3068 | 0.1290 | 0.8343 | 36.0 | 0.8290 | 20.9 | 0.8243 | 43.1 |
| Example 6 | 2.4351 | 2.3066 | 0.1285 | 0.8319 | 35.1 | 0.8285 | 23.1 | 0.8245 | 41.8 |
| Comparative | 2.424 | 2.311 | 0.1130 | — | 0 | 0.8201 | 100 | — | 0 |
| Example 1 | | | | | | | | | |
| Comparative | 2.4469 | 2.2997 | 0.1472 | 0.8390 | 43.0 | 0.8262 | 26.2 | 0.8235 | 30.8 |
| Example 2 | | | | | | | | | |

TABLE 2

| | Peak intermediate | Variation in lattice constant (Å) | |
|---|---|---|---|
| | intensity ratio (%) | a Axis | c Axis |
| Example 1 | 67 | 0.059 | 0.853 |
| Example 2 | 50 | 0.062 | 0.926 |
| Example 3 | 17 | 0.067 | 1.06 |
| Example 4 | 20 | 0.066 | 0.982 |
| Example 5 | 31 | 0.062 | 0.978 |
| Example 6 | 45 | 0.06 | 0.953 |
| Comparative | 85 | 0.054 | 0.713 |
| Example 1 | | | |
| Comparative | 15 | 0.069 | 1.13 |
| Example 2 | | | |

TABLE 3

| | | | | | Gas |
|---|---|---|---|---|---|
| | Charge | Discharge | | Capacity | production |
| | capacity | capacity | Efficiency | retention | amount |
| | (mAh/g) | (mAh/g) | (%) | rate (%) | (ml) |
| Example 1 | 245.1 | 226 | 92.2 | 81 | 2.4 |
| Example 2 | 246.5 | 228.5 | 92.7 | 72 | 5.3 |
| Example 3 | 250.2 | 231.2 | 92.4 | 60 | 7.0 |
| Example 4 | 250.4 | 231.5 | 92.3 | 65 | 6.8 |
| Example 5 | 251.0 | 230.8 | 92.0 | 70 | 5.5 |
| Example 6 | 250.9 | 230.6 | 91.9 | 74 | 4.7 |
| Comparative | 230.8 | 208.7 | 90.4 | 75 | 3.0 |
| Example 1 | | | | | |
| Comparative | 244.8 | 220.4 | 90.0 | 75 | 7.2 |
| Example 2 | | | | | |

Referring to Table 1 above, in the lithium-nickel metal oxides of the lithium secondary batteries according to the examples, the expansion phase peak integral area ratios were 30% to 40%, and the contraction phase peak integral area ratios were 35% to 45% measured in the voltage region of 3.75 V to 4.15 V through the in-situ XRD.

Accordingly, referring to Table 2, it can be confirmed that the lithium secondary batteries of the examples have high charge and discharge capacities, battery efficiency, and the capacities are maintained high with low gas generation amount even after 500 cycles. In particular, in addition to Example 3 in which the content of Ni among the metal elements except for lithium is 98 mol %, it can be confirmed that Examples 4 to 6 doped with metal elements have a small variation in the lattice constant and improved capacity retention rate, thereby improving lifespan characteristics and reducing gas generation amount. In addition, it can be confirmed that, as the types of doping metals are increased, a lithium secondary battery having the more improved characteristics is implemented.

Further, referring to FIGS. 3 to 5, in the case of the lithium-nickel metal oxides included in the lithium secondary batteries according to the examples, it can be confirmed that the peak of the (003) plane varies from H2 to H3 phase transition along the arrow in the phase transition process during charging and discharging. Specifically, intermediate peaks were observed in the process of moving from the H2 peak at about 18.5° to the H3 peak at about 19.5° at a speed of about 0.71° /1.8 min.

At this time, it can be confirmed that a battery having improved lifespan characteristics may be implemented as the intensity of the intermediate peak varies gently without rapid changes. For example, in the case of Examples 4 to 6, the intermediate peak height is high, such that the peak change occurs in a more gentle form than in Example 3, and it can be confirmed that the crystal structure does not change more drastically during charging and discharging.

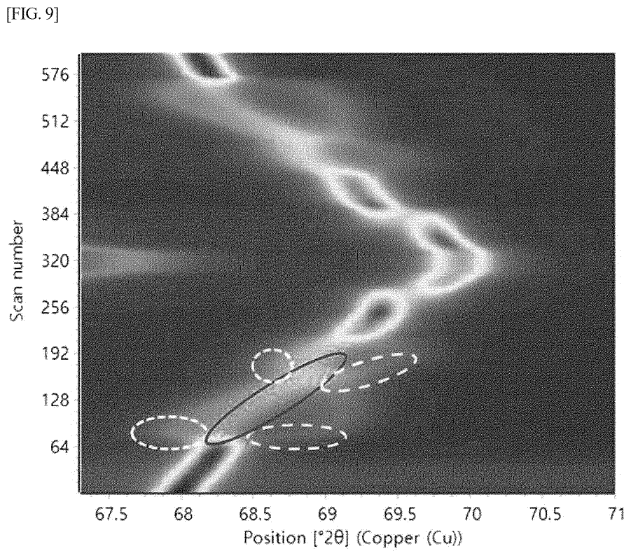

Referring to FIGS. 6 to 11, it can be confirmed that the (113) plane peak is separated into three peaks in the low voltage range (about 70 to 200 scan numbers on a vertical axis). For example, referring to FIG. 9, it can be confirmed that one peak observed at the scan number of less than about 70 is separated into three peaks in the range of scan numbers of about 70 to 200. In FIG. 9, a main phase peak indicated by a solid ellipse, expansion phase peaks indicated by dashed ellipses on the left of the main phase peak and contraction phase peaks indicated by dashed ellipses on the right of the main phase peak can be confirmed.

On the other hand, the battery of Comparative Example 1 provided a low-capacity battery by including a cathode active material with a low nickel content.

In addition, in the case of Comparative Example 2, the contraction phase peak ratio measured in the voltage region of 3.75 V to 4.15 V by in-situ XRD was low and the expansion phase peak ratio was high, such that the charge and discharge capacities were decreased and the capacity retention rate was decreased. In addition, the expansion phase and the contraction phase of the cathode active material particles changed within an excessively wide range, and the variation in the crystal structure of the particles was increased, thereby causing an increase in the gas generation amount. Accordingly, the battery of Comparative Example 2 did not have a high capacity even though it included a cathode active material with a high nickel content, and provided greatly deteriorated electrochemical properties.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. A cathode active material for a lithium secondary battery comprising:
lithium-nickel metal oxide particles which comprise 90 mol % to 99 mol % of Ni among metal elements except for lithium,
wherein a (113) plane peak of the lithium-nickel metal oxide particles measured through in-situ X-ray diffraction analysis (in-situ XRD) is separated into a main phase peak having the highest peak intensity in a voltage region of 3.75 V to 4.15 V; an expansion phase peak appearing at a first diffraction angle smaller than a main diffraction angle at which the main phase peak appears; and a contraction phase peak appearing at a second diffraction angle larger than the main diffraction angle, and
a ratio of an integral area of the expansion phase peak to a sum of integral areas of the main phase peak, the expansion phase peak and the contraction phase peak is 30 to 40%, and a ratio of the integral area of the contraction phase peak to the sum of integral areas is 35 to 45%.

2. The cathode active material for a lithium secondary battery according to claim 1, wherein a difference between the main diffraction angle and the first diffraction angle is greater than 0 and 1° or less, and a difference between the main diffraction angle and the second diffraction angle is greater than 0 and 1° or less.

3. The cathode active material for a lithium secondary battery according to claim 1, wherein the lithium-nickel metal oxide particles comprise at least one doping element.

4. The cathode active material for a lithium secondary battery according to claim 1, wherein the lithium-nickel metal oxide particles are represented by Formula 1 below:
LiₓNiₐCo_{b}Mn_{c}M_{d}O_{2+y} [Formula 1]
(in Formula 1, M includes at least one of Ti, Zr, Al, Mg, Sr and W, and x, a, b, c, d and y satisfy 0.8<x<1.5, 0.90≤a≤0.99, 0≤b≤0.10, 0≤c≤0.10, 0≤d≤0.05, 0.98≤a+b+c≤1.02, −0.1≤y≤0.1).

5. The cathode active material for a lithium secondary battery according to claim 4, wherein in Formula 1 above, a is in a range of 0.94≤a≤0.98.

6. The cathode active material for a lithium secondary battery according to claim 4, wherein in Formula 1 above, b is in a range of 0≤b≤0.05.

7. The cathode active material for a lithium secondary battery according to claim 4, wherein in Formula 1 above, c is in a range of 0≤c≤0.05.

8. The cathode active material for a lithium secondary battery according to claim 4, wherein in Formula 1 above, c is b or less (c≤b).

9. The cathode active material for a lithium secondary battery according to claim 4, wherein in Formula 1 above, M includes two or more of Ti, Zr, Al, Mg, Sr and W.

10. The cathode active material for a lithium secondary battery according to claim 1, wherein a variation in a d value of the lithium-nickel metal oxide particles measured in a voltage region of greater than 4.15 V and 4.18 V or less through the in-situ X-ray diffraction analysis (in-situ XRD) is 0.1 to 0.15.

11. The cathode active material for a lithium secondary battery according to claim 1, wherein a variation in an a-axis lattice constant among the lattice constants of the lithium-nickel metal oxide particles measured through the in-situ X-ray diffraction analysis (in-situ XRD) is 0.05 to 0.08 Å, and a variation in a c-axis lattice constant is 0.8 to 1.2 Å.

12. A lithium secondary battery comprising:
a cathode which comprises the cathode active material for a lithium secondary battery of claim 1; and
an anode disposed to face the cathode.
